(19) United States
(12) Patent Application Publication
(10) Pub. No.: US 2026/0331811 A1
(43) Pub. Date: Oct. 22, 2026

(54) ELECTRICAL CONNECTOR WITH IMPROVED TERMINAL MODULE

(71) Applicant: SPEED TECH CORPORATION, Taoyuan City (TW)

(72) Inventor: Chihcheng CHEN, Taoyuan City (TW)

(73) Assignee: SPEED TECH CORPORATION, Taoyuan City (TW)

(21) Appl. No.: 19/629,342

(22) Filed: Mar. 26, 2026

(30) Foreign Application Priority Data
Apr. 22, 2025 (CN) 202510505492.8

(51) Int. Cl. H01R 13/422; H01R 12/72; H01R 13/03; H01R 13/504; H01R 13/518; H01R 13/6471

(52) U.S. Cl. CPC H01R 13/4223; H01R 12/721; H01R 13/03; H01R 13/5045; H01R 13/518; H01R 13/6471

(57) ABSTRACT

An electrical connector includes an insulating body, a first terminal module and a first mounting block. The insulating body includes a mating portion and a mounting portion. The mating portion includes a mating surface and a mating slot. The mounting portion includes a mounting groove, a first positioning slot, and a first locking hole in communication with the mating slot. The first terminal module includes a first insulating block and a number of first conductive terminals. The first mounting block is located on one side of the first terminal module and cooperates with the first terminal module. The first insulating block and the first mounting block are both installed at least partially in the mounting groove. The first mounting block is provided with a first positioning rib engaged in the first positioning slot, and a first locking protrusion locked in the first locking hole.

### CROSS-REFERENCE TO RELATED APPLICATION

This patent application claims priority of a Chinese Patent Application No. 202510505492.8, filed on Apr. 22, 2025 and titled “ELECTRICAL CONNECTOR”, the entire content of which is incorporated herein by reference.

### TECHNICAL FIELD

The present disclosure relates to an electrical connector, which belongs to the field of connector technology.

### BACKGROUND

An electrical connector in the related art includes an insulating body and a terminal module mounted to the insulating body. The insulating body includes a mating slot and a mounting groove. The terminal module includes an insulating block and a plurality of conductive terminals coupled to the insulating block. The insulating block is at least partially mounted in the mounting groove. The conductive terminal includes a contact portion protruding into the mating slot.

However, there is still room for improvement in terms of how to install the terminal module to the insulating body in the related art.

### SUMMARY

An embodiment of the present disclosure adopts the following technical solution: an electrical connector, including: an insulating body, the insulating body including a mating portion and a mounting portion; the mating portion including a mating face and a mating slot extending through the mating face; the mounting portion defining a mounting groove communicating with the mating slot, a first positioning slot extending through the mounting portion along a first direction, and a first locking hole extending along a second direction; both the first positioning slot and the first locking hole communicating with the mounting groove; a first terminal module, the first terminal module being at least partially disposed in the insulating body, the first terminal module including a first insulating block and a plurality of first conductive terminals coupled to the first insulating block; a first mounting block, the first mounting block being located on one side of the first terminal module and cooperating with the first terminal module; wherein both the first insulating block and the first mounting block are at least partially installed in the mounting groove; and the first mounting block is provided with a first positioning rib engaged in the first positioning slot, and a first locking protrusion locked in the first locking hole.

### BRIEF DESCRIPTION OF DRAWINGS

FIG. 1 is a perspective schematic view an electrical connector in accordance with a first embodiment of the present disclosure;

FIG. 2 is a perspective view of FIG. 1 from another angle;

FIG. 3 is a front view of FIG. 2;

FIG. 4 is a rear view of FIG. 2;

FIG. 5 is a top view of FIG. 2;

FIG. 6 is a bottom view of FIG. 2;

FIG. 7 is a left view of FIG. 2;

FIG. 8 is a right view of FIG. 2;

FIG. 9 is a partially exploded view of FIG. 1;

FIG. 10 is a partially perspective exploded view of FIG. 9 from another angle;

FIG. 11 is a partially perspective exploded view of one terminal module in FIG. 9;

FIG. 12 is a partially exploded view of FIG. 11 from another angle;

FIG. 13 is a further partially exploded view of FIG. 11;

FIG. 14 is a partially exploded view of FIG. 13 from another angle;

FIG. 15 is a further partially exploded view of FIG. 13;

FIG. 16 is a partially exploded view of FIG. 15 from another angle;

FIG. 17 is a further exploded perspective view of FIG. 15;

FIG. 18 is a perspective exploded view of FIG. 17 from another angle;

FIG. 19 is a cross-sectional view taken along line F-F in FIG. 2;

FIG. 20 is a partial enlarged view of frame portion B in FIG. 19;

FIG. 21 is a partial enlarged view of frame portion C in FIG. 20;

FIG. 22 is a perspective schematic view the electrical connector in accordance with a second embodiment of the present disclosure;

FIG. 23 is a cross-sectional view taken along line G-G in FIG. 22; and

FIG. 24 is a partial enlarged view of frame portion E in FIG. 23.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

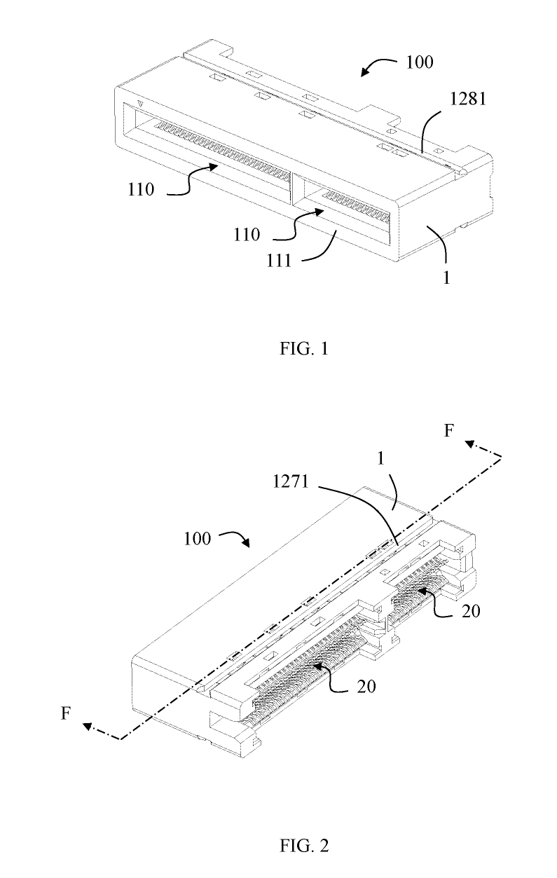

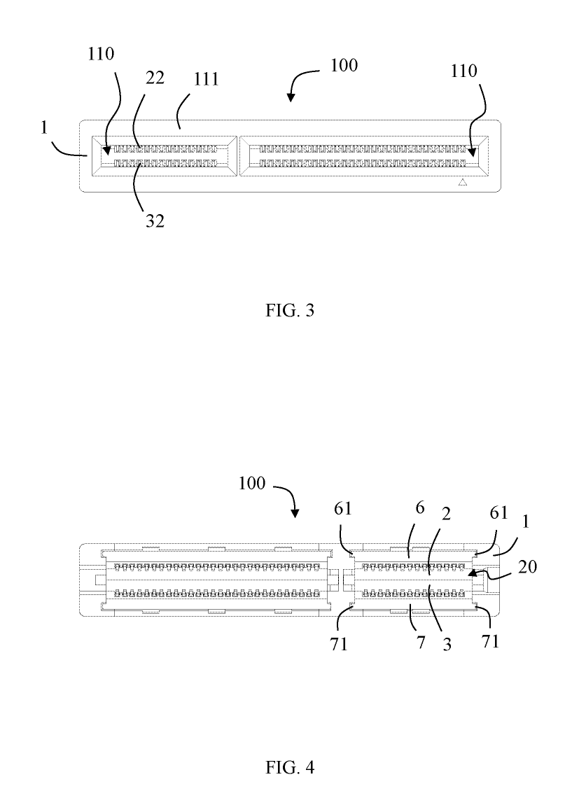

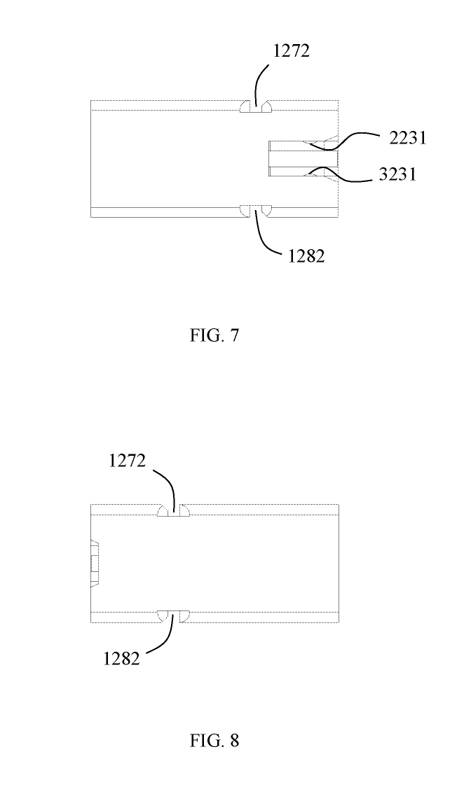

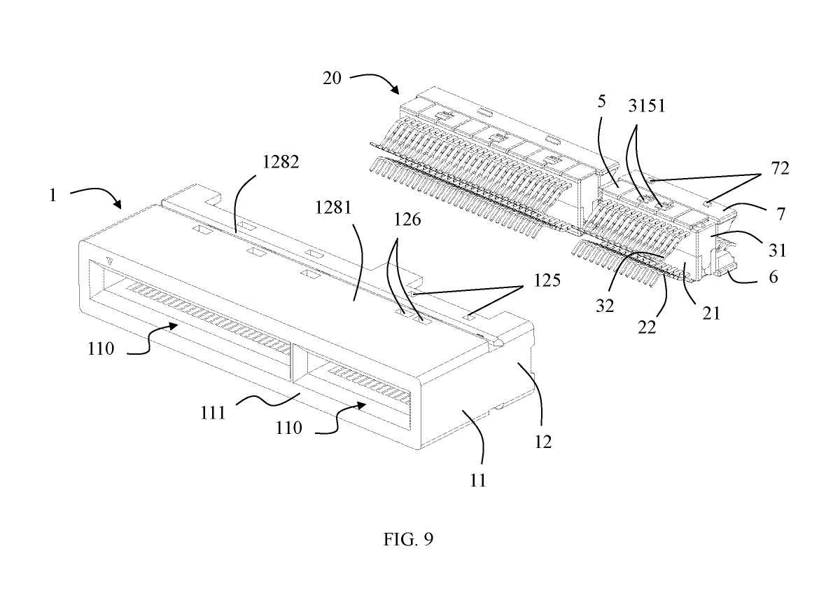

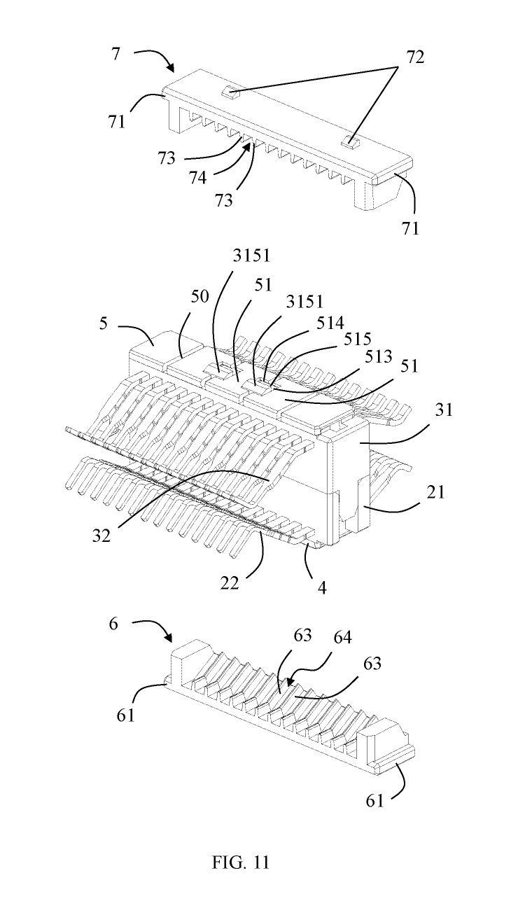

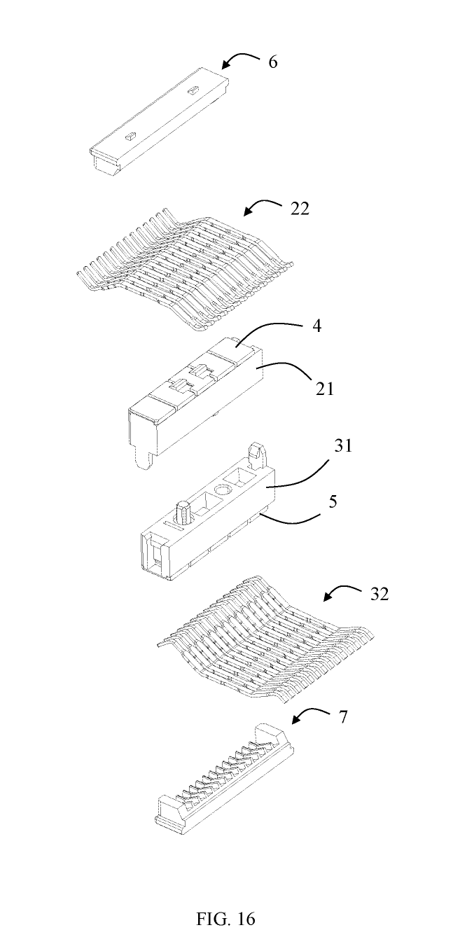

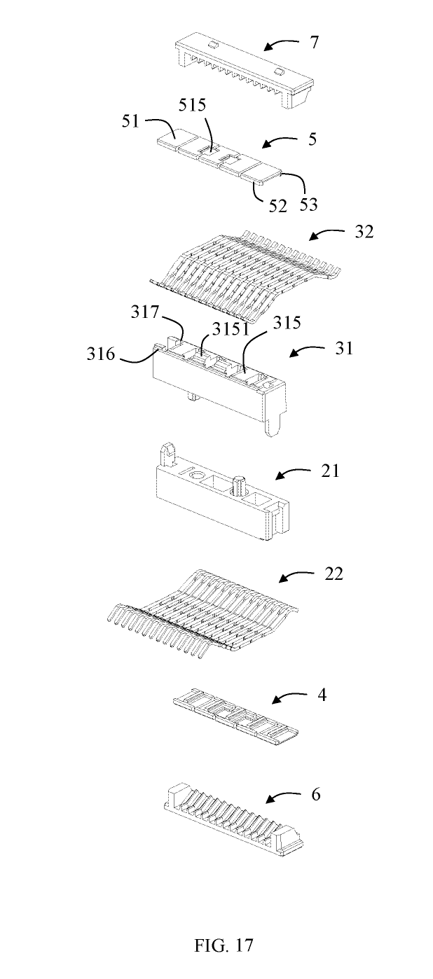

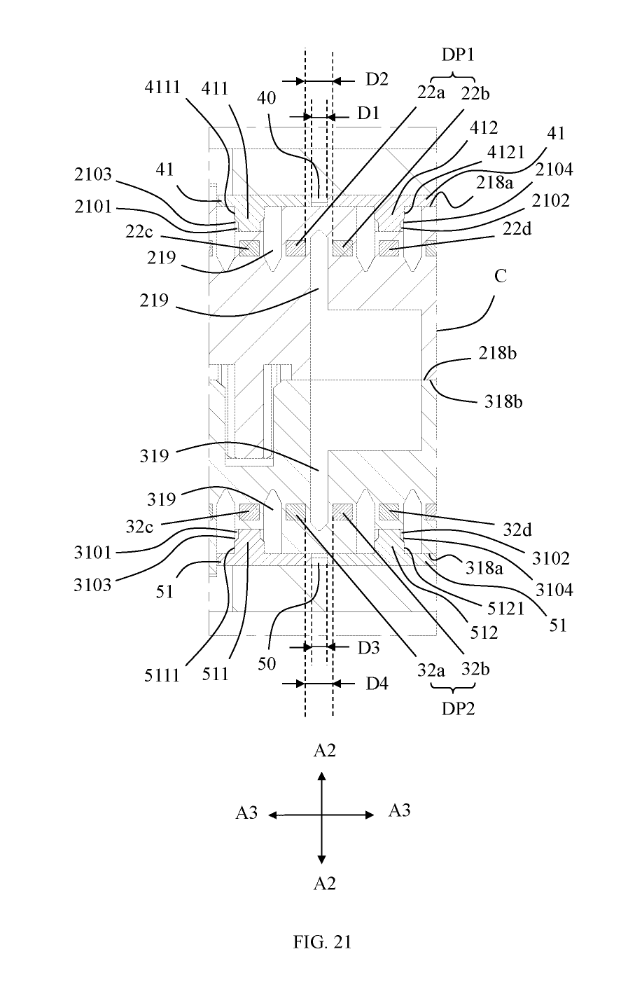

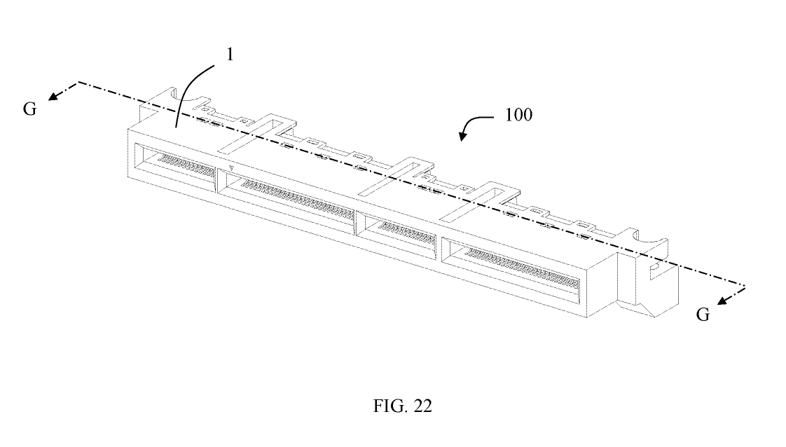

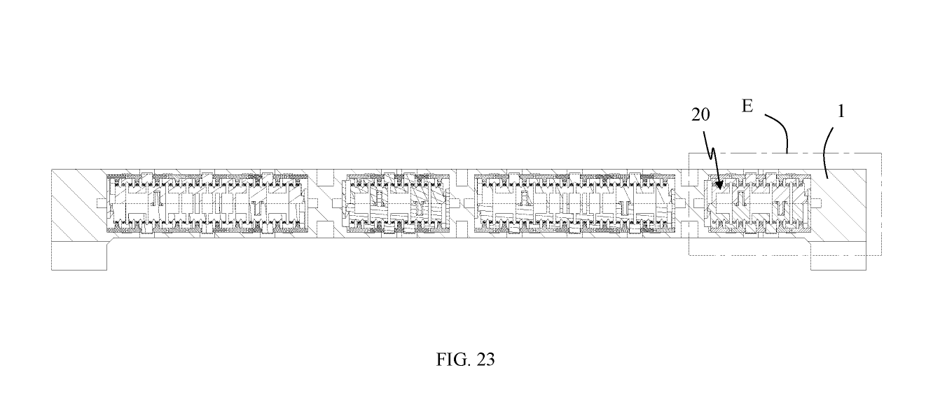

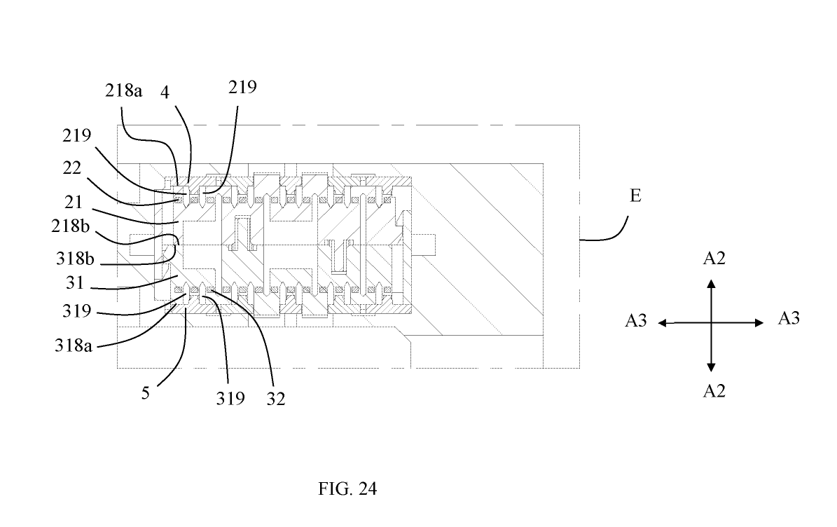

Referring to FIGS. 1 to 24, the present disclosure discloses an electrical connector 100 including an insulating body 1 and a plurality of terminal blocks 20 mounted to the insulating body 1. In the illustrated embodiment of the present disclosure, the electrical connector 100 is a card edge connector for mating with a mating module (for example, an electrical card, not shown). The structures of the terminal blocks 20 are approximately the same, but the number and size of the related components vary.

Referring to FIGS. 9 to 18, only one of the terminal blocks 20 is used as an example for detailed description. The terminal block 20 includes a first terminal module 2, a second terminal module 3, a first conductor 4 cooperating with the first terminal module 2, a second conductor 5 cooperating with the second terminal module 3, a first mounting block 6 retained in the insulating body 1 and cooperating with the first terminal module 2, and a second mounting block 7 retained in the insulating body 1 and cooperating with the second terminal module 3.

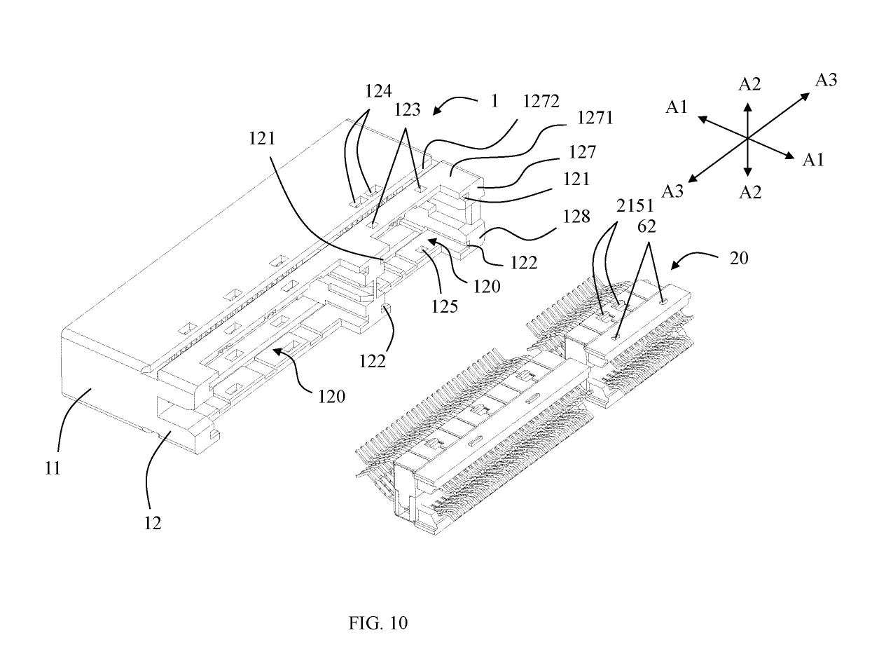

Referring to FIGS. 9 and 10, in the illustrated embodiment of the present disclosure, the insulating body 1 includes a mating portion 11 and a mounting portion 12. In the illustrated embodiment of the present disclosure, the mating portion 11 is integrally formed with the mounting portion 12. The mating portion 11 includes a mating surface 111 and a mating slot 110 extending through the mating surface 111. The mounting portion 12 defines a mounting groove 120 communicating with the mating slot 110, at least one first positioning slot 121 extending backwardly through the mounting portion 12 in a first direction A1-A1 (for example, a front-rear direction), at least one second positioning slot 122 extending backwardly through the mounting portion 12 along the first direction A1-A1, at least one first locking hole 123 extending in a second direction A2-A2 (for example, a top-bottom direction), at least one second locking hole 124 extending in the second direction A2-A2, at least one third locking hole 125 extending in the second direction A2-A2, and at least one fourth locking hole 126 extending in the second direction A2-A2. In the illustrated embodiment of the present disclosure, two first positioning slots 121 are provided, and located on two sides of an upper portion of the mounting groove 120, respectively. Two second positioning slots 122 are provided, and located on two sides of a lower portion of the mounting groove 120, respectively. The first positioning slots 121 and the second positioning slots 122 are arranged in the second direction A2-A2. A plurality of first locking holes 123 are provided, and arranged at intervals along a third directions A3-A3 (for example, a left-right direction). In the illustrated embodiment of the present disclosure, each first locking hole 123 is perforated. That is, each first locking hole 123 extends upwardly through the mounting portion 12 along the second direction A2-A2. A plurality of second locking holes 124 are provided, and arranged at intervals along the third direction A3-A3. In the illustrated embodiment of the present disclosure, each second locking hole 124 is perforated. That is, each second locking hole 124 extends upwardly through the mounting portion 12 along the second direction A2-A2. The second locking holes 124 and the first locking holes 123 are arranged in front and rear rows along the first direction A1-A1. In the illustrated embodiment of the present disclosure, each two of the first direction A1-A1, the second direction A2-A2 and the third A3-A3 are perpendicular to each other. Of course, it is understandable to those skilled in the art that in other embodiments of the present disclosure, the first locking holes 123 and/or the second locking holes 124 may also be blind holes. That is, the first locking holes 123 and/or the second locking holes 124 are recessed into the mounting portion 12, but do not extend upwardly through the mounting portion 12.

Similarly, a plurality of third locking holes 125 are provided, and arranged at intervals along the third direction A3-A3. In the illustrated embodiment of the present disclosure, each third locking hole 125 is perforated. That is, each third locking hole 125 extends downwardly through the mounting portion 12 along the second direction A2-A2. A plurality of fourth locking holes 126 are provided, and arranged at intervals along the third direction A3-A3. In the illustrated embodiment of the present disclosure, each fourth locking hole 126 is perforated. That is, each fourth locking hole 126 extends downwardly through the mounting portion 12 along the second direction A2-A2. The fourth locking holes 126 and the third locking holes 125 are arranged in front and rear rows along the first direction A1-A1. Of course, it is understandable to those skilled in the art that in other embodiments of the present disclosure, the third locking holes 125 and/or the fourth locking holes 126 may also be blind holes. That is, the third locking holes 125 and/or the fourth locking holes 126 are recessed into the mounting portion 12, but do not extend downwardly through the mounting portion 12.

In the illustrated embodiment of the present disclosure, the first positioning slot 121, the second positioning slot 122, the first locking holes 123, the second locking holes 124, the third locking holes 125 and the fourth locking holes 126 are all in communication with the mounting groove 120.

Specifically, in the illustrated embodiment of the present disclosure, the mounting portion 12 includes a first wall portion 127 (for example, an upper wall portion) and a second wall portion 128 (for example, a lower wall portion) opposite the first wall portion 127. The first positioning slot 121, the first locking holes 123 and the second locking holes 124 are all provided on the first wall portion 127. The second positioning slot 122, the third locking holes 125 and the fourth locking holes 126 are all provided on the second wall portion 128.

Besides, in conjunction with FIGS. 1 to 10, in the illustrated embodiment of the present disclosure, the first wall portion 127 is provided with a first outer surface 1271 (for example, an upper surface) and a first slit 1272 extending through the first outer surface 1271. The first slit 1272 extends in the third direction A3-A3, and extends through two sides of the first wall portion 127. In the illustrated embodiment of the present disclosure, the first locking holes 123 and the second locking holes 124 extend upwardly through the first outer surface 1271. Similarly, the second wall portion 128 is provided with a second outer surface 1281 (for example, a lower surface) and a second slit 1282 extending through the second outer surface 1281. The second slit 1282 extends in the third direction A3-A3, and extends through two sides of the second wall portion 128. In the illustrated embodiment of the present disclosure, the third locking holes 125 and the fourth locking holes 126 extend downwardly through the second outer surface 1281.

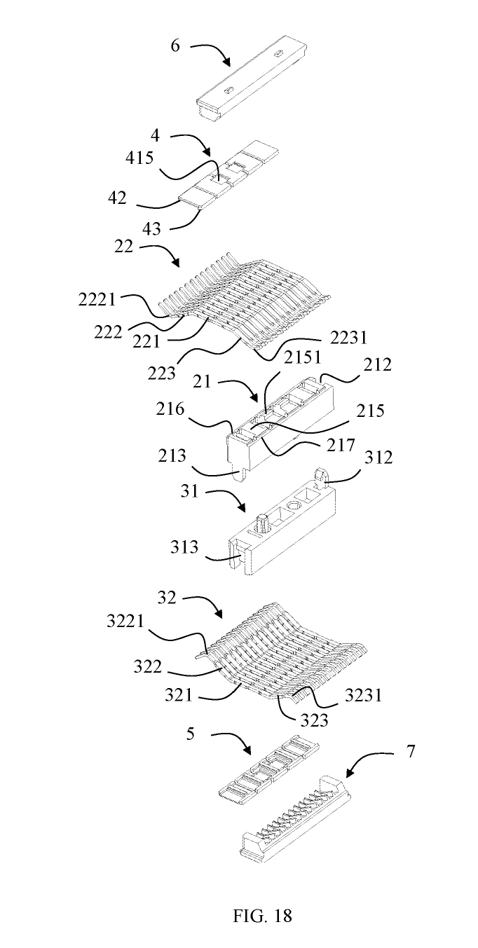

Referring to FIG. 18, the first terminal module 2 includes a first insulating block 21 and a plurality of first conductive terminals 22 coupled to the first insulating block 21. The first conductive terminal 22 includes a first fixing portion 221 fixed to the first insulating block 21, a first mating elastic arm 222 extending from one end (for example, a front end) of the first fixing portion 221, and a first mounting elastic arm 223 extending from another end (for example, a rear end) of the first fixing portion 221. In one embodiment of the present disclosure, the first insulating block 21 is injection-molded on the first conductive terminals 22. The first mating elastic arm 222 is provided with a first contact portion 2221 protruding into the mating slot 110. The first mounting elastic arm 223 is provided with a first abutting portion 2231 protruding into the mounting groove 120. The first contact portion 2221 and the first abutting portion 2231 are both arc-shaped.

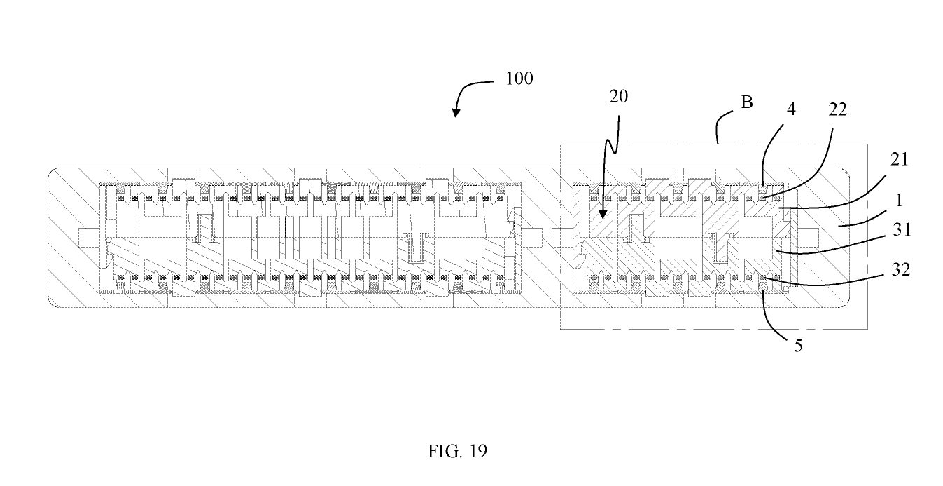

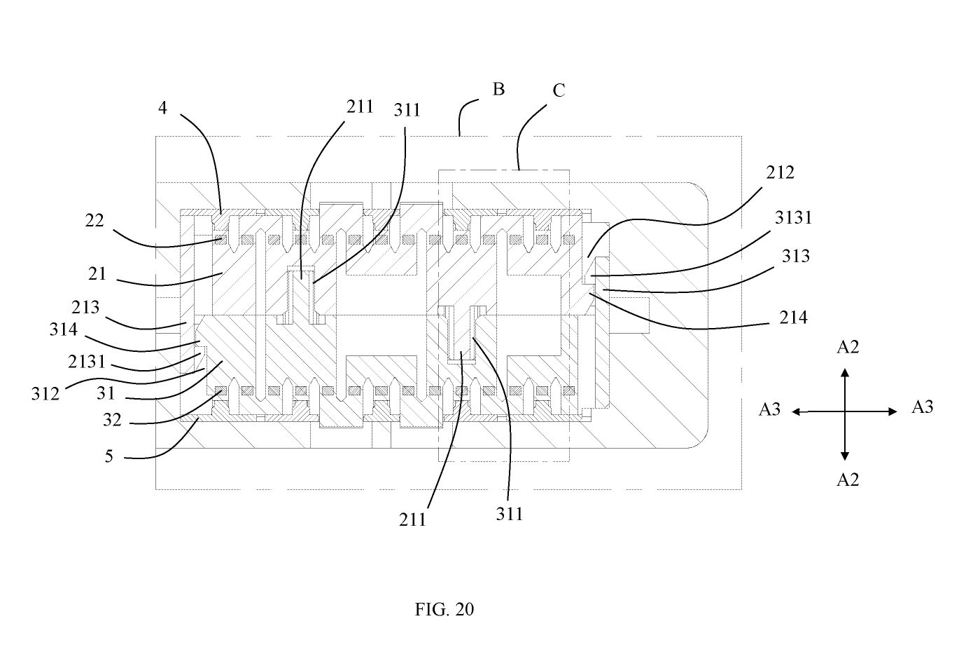

In conjunction with FIGS. 19 and 20, in one embodiment of the disclosure, the first conductive terminals 22 include a plurality of first signal terminals 22a, a plurality of second signal terminals 22b, a plurality of first ground terminals 22c, and a plurality of second ground terminals 22d. Adjacent first signal terminal 22a and second signal terminal 22b form a first differential pair DP1 to increase the signal transmission rate. One side of each first differential pair DP1 is provided with one first ground terminal 22c, and another side of each first differential pair DP1 is provided with one second ground terminal 22d so as to improve the quality of signal transmission.

Referring to FIG. 18, the second terminal module 3 includes a second insulating block 31 and a plurality of second conductive terminals 32 coupled to the second insulating block 31. The second conductive terminal 32 includes a second fixing portion 321 fixed to the second insulating block 31, a second mating elastic arm 322 extending from one end (for example, a front end) of the second fixing portion 321, and a second mounting arm portion 323 extending from another end (for example, a rear end) of the second fixing portion 321. In one embodiment of the present disclosure, the second insulating block 31 is injection-molded on the second conductive terminals 32. The second mating elastic arm 322 is provided with a second contact portion 3221 protruding into the mating slot 110. The second mounting elastic arm 323 is provided with a second abutting portion 3231 protruding into the mounting groove 120. The second contact portion 3221 and the second abutting portion 3231 are both arc-shaped.

In conjunction with FIGS. 19 and 20, in one embodiment of the present disclosure, the second conductive terminals 32 include a plurality of third signal terminals 32a, a plurality of fourth signal terminals 32b, a plurality of third ground terminals 32c, and a plurality of fourth ground terminals 32d. Adjacent third signal terminal 32a and fourth signal terminal 32b form a second differential pair DP2 to increase the signal transmission rate. One side of each second differential pair DP2 is provided with one third ground terminal 32c, and another side of each second differential pair DP2 is provided with one fourth ground terminal 32d so as to improve the quality of signal transmission.

In the illustrated embodiment of the present disclosure, the first mating elastic arms 222 are located in an upper row of the mating slot 110; and the second mating elastic arms 322 are located in a lower row of the mating slot 110. After the mating module is inserted into the mating slot 110, the mating module is clamped between the first mating elastic arms 222 and the second mating elastic arms 322. The first contact portions 2221 abut against first gold fingers of the mating module, and the second contact portions 3221 abut against second gold fingers of the mating module to achieve electrical conduction.

In the illustrated embodiment of the present disclosure, the first mounting arm portions 223 are located in an upper row of the mounting groove 120, and the second mounting elastic arms 323 are located in a lower row of the mounting groove 120. The electrical connector 100 is configured to cooperate with a connecting component (for example, a circuit board). The circuit board is sandwiched between the first mounting elastic arms 223 and the second mounting elastic arms 323. The first abutting portions 2231 of the first mounting elastic arms 223 and the second abutting portions 3231 of the second mounting elastic arms 323 are in contact with the conductive pads on the circuit board to achieve electrical conduction.

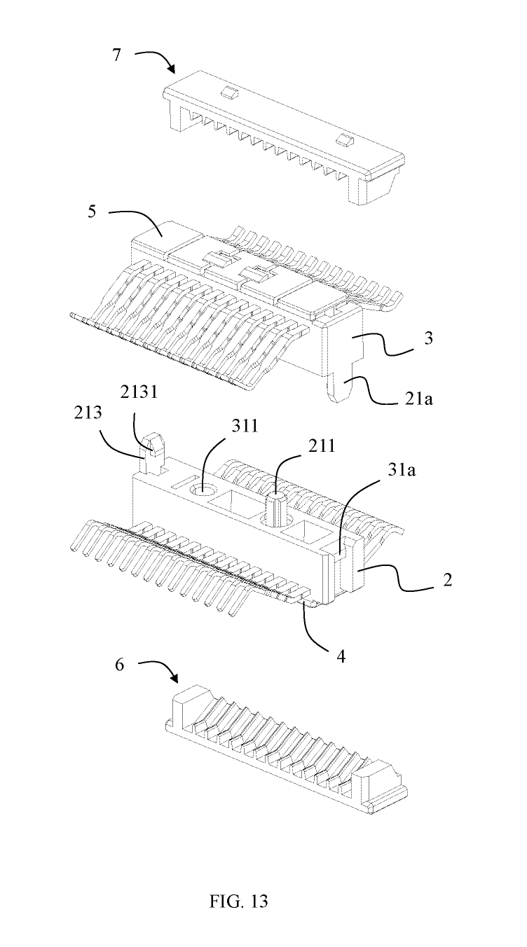

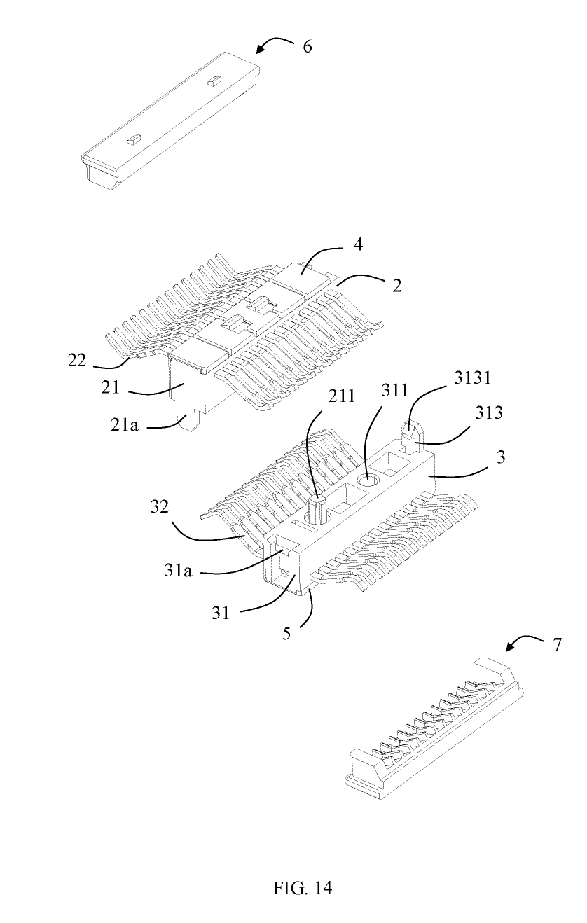

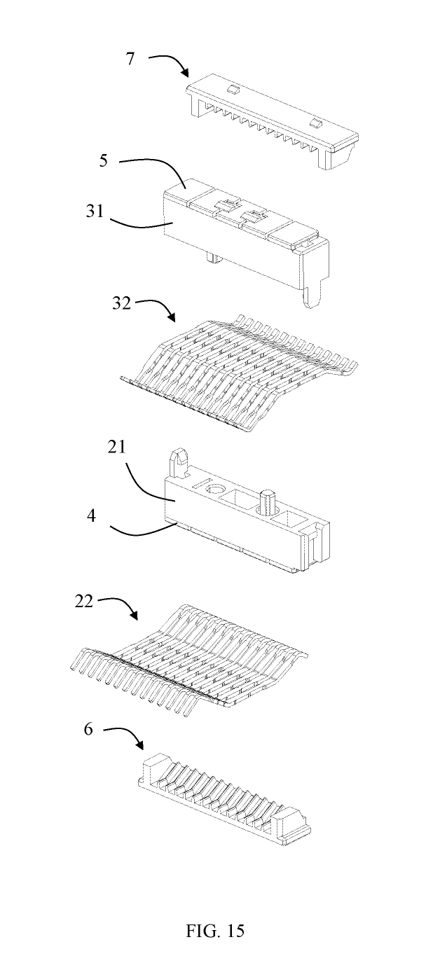

Referring to FIGS. 13 and 14, in the illustration embodiment of the present disclosure, the first insulating block 21 and the second insulating block 31 are provided with at least one positioning post 211 and at least one positioning hole 311 that cooperate with each other. In the illustrated embodiment of the present disclosure, each of the first insulating block 21 and the second insulating block 31 is provided with the positioning post 211 and the positioning hole 311. The positioning post 211 of the first insulating block 21 cooperates with the positioning hole 311 of the second insulating block 31. Meanwhile, the positioning post 211 of the second insulating block 31 cooperates with the positioning hole 311 of the first insulating block 21.

Besides, the first insulating block 21 and the second insulating block 31 are provided with a locking elastic arm 21a and a locking boss 31a that cooperate with each other.

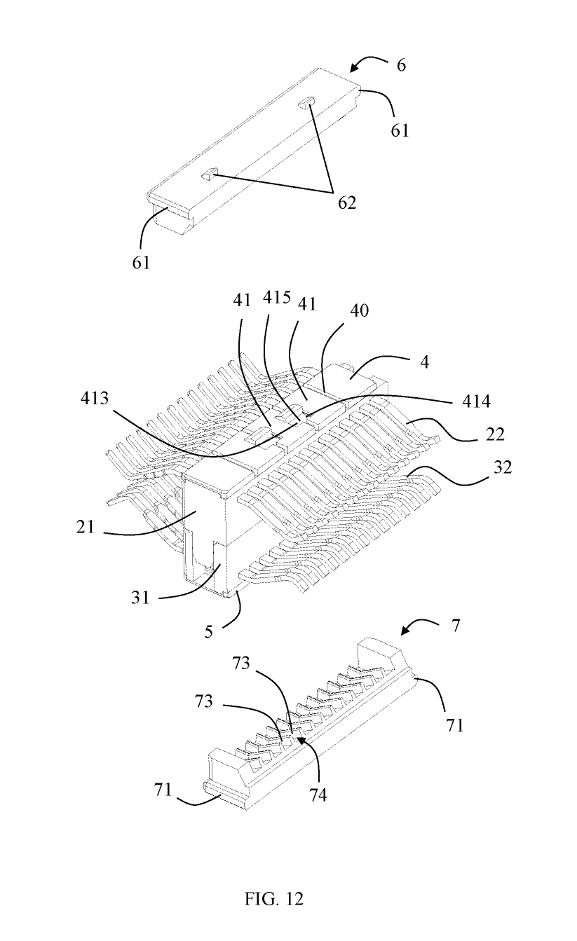

Referring to FIGS. 12 and 20, specifically, in the illustration embodiment of the present disclosure, the first insulating block 21 includes a first recess 212 located on one side (for example, a right side) of the first insulating block 21, and a first engaging elastic arm 213 located on another side (for example, a left side) of the first insulating block 21. The first insulating block 21 is provided with a first boss 214 located in the first recess 212. The first engaging elastic arm 213 is provided with a first locking hook 2131.

The second insulating block 31 includes a second recess 312 located on one side (for example, a left side) of the second insulating block 31, and a second engaging elastic arm 313 located on another side (for example, a right side) of the second insulating block 31. The second insulating block 31 includes a second boss 314 located in the second recess 312. The second engaging elastic arm 313 is provided with a second locking hook 3131.

Referring to FIG. 20, when the first insulating block 21 and the second insulating block 31 cooperate with each other, the first engaging elastic arm 213 is received in the second recess 312, and the first locking hook portion 2131 is locked with the second boss 314. The second engaging elastic arm 313 is received in the first recess 212, and the second locking hook portion 3131 is locked with the first boss 214.

In the illustrated embodiment of the present disclosure, the locking elastic arm 21a includes the first engaging elastic arm 213 and the second engaging elastic arm 313. The locking boss 31a includes the first boss 214 and the second boss 314.

Besides, the first insulating block 21 includes a first protruding portion 215 located in the middle, a first recess 216 located on one side (for example, a front side) of the first protruding portion 215, and a second recess 217 located on another side (for example, a rear side) of the first protruding portion 215. The first insulating block 21 further includes a first surface 218a (for example, an upper surface), a second surface 218b (for example, a lower surface) disposed opposite to the first surface 218a, and a plurality of first impedance adjustment holes 219. Referring to FIG. 20, the plurality of first impedance adjustment holes 219 are arranged at intervals along the third direction A3-A3. The first impedance adjustment holes 219 extend through at least one of the first surface 218a and the second surface 218b. In the illustrated embodiment of the present disclosure, in at least one group of adjacent two first impedance adjustment holes 219, one of the first impedance adjustment holes 219 extends upwardly through the first surface 218a, and a remaining one of the first impedance adjustment holes 219 extends downwardly through the second surface 218b. The first protruding portion 215 is provided with a plurality of second locking protrusions 2151. The second locking protrusions 2151 are locked in the second locking holes 124. The first impedance adjustment holes 219 extend in the second direction A2-A2. Each first impedance adjustment hole 219 is located between two adjacent first conductive terminals 22.

Besides, the second insulating block 31 includes a second protruding portion 315 located in the middle, a third recess 316 located on one side (for example, a front side) of the second protruding portion 315, and a fourth recess 317 located on another side (for example, a rear side) of the second protruding portion 315. The second insulating block 31 further includes a third surface 318a (for example, a lower surface), a fourth surface 318b (for example, an upper surface) disposed opposite to the third surface 318a, and a plurality of second impedance adjustment holes 319. Th plurality of second impedance adjustment holes 319 are arranged at intervals along the third direction A3-A3. The second impedance adjustment holes 319 extend through at least one of the third surface 318a and the fourth surface 318b. Referring to FIG. 20, in the illustrated embodiment of the present disclosure, in at least one group of adjacent two second impedance adjustment holes 319, one of the second impedance adjustment holes 319 extends downwardly through the third surface 318a, and a remaining one of the second impedance adjustment holes 319 extends upwardly through the fourth surface 318b. The second protruding portion 315 is provided with a plurality of fourth locking protrusions 3151. The fourth locking protrusions 3151 are locked in the fourth locking holes 126. The second impedance adjustment holes 319 extend in the second direction A2-A2. Each second impedance adjustment hole 319 is located between two adjacent second conductive terminals 32.

Preferably, the second terminal module 3 and the first terminal module 2 are the same parts with different angles to save costs.

The first conductor 4 is mounted to the first insulating block 21. The first conductor 4 is at least partially mounted in the mounting groove 120. In the illustrated embodiment of the present disclosure, the first conductor 4 is conductive plastic. The first conductor 4 includes a plurality of first conductive pads 41 arranged at intervals. A first gap 40 is provided between any adjacent two first conductive pads 41. The first gap 40 is located on one side (for example, an upper side) of the first signal terminal 22a and the second signal terminal 22b in the second direction A2-A2. The first gap 40 is located between the first signal terminal 22a and the second signal terminal 22b in the third direction A3-A3. The first gap 40 is able to prevent signals on the conductive plastic from affecting each other, thereby avoiding signal crosstalk. Referring to FIG. 20, in one embodiment of the present disclosure, a dimension of the first gap 40 along the third direction A3-A3 is D1, and a spacing between the first signal terminal 22a and the second signal terminal 22b along the third direction A3-A3 is D2, where (1/2)*D2≤D1≤(4/5)*D2.

The first insulating block 21 includes a plurality of first retaining grooves 2101 which are arranged corresponding to the first ground terminals 22c in the second direction A2-A2, and spaced from the first ground terminals 22c in the second direction A2-A2, and a plurality of second retaining grooves 2102 which are arranged corresponding to the second ground terminals 22d in the second direction A2-A2, and spaced from the second ground terminals 22d in the second direction A2-A2. The first insulating block 21 is provided with first inner wall surfaces 2103 located on two sides of the first retaining groove 2101, and second inner wall surfaces 2104 located on two sides of the second retaining groove 2102.

In two adjacent first conductive pads 41, one of the first conductive pads 41 is provided with a first retaining protrusion 411 fixed in the first retaining groove 2101, and a remaining one of the first conductive pads 41 is provided with a second retaining protrusion 412 fixed in the second retaining groove 2102. The first retaining protrusion 411 is provided with first ribs 4111 located on two sides thereof. The first ribs 4111 abut against the first inner wall surface 2103. The first ribs 4111 are disposed adjacent to the first ground terminal 22c in order to improve the quality of signal transmission. The second retaining protrusion 412 is provided with second ribs 4121 located on two sides thereof. The second ribs 4121 abut against the second inner wall surface 2104. The second ribs 4121 are disposed adjacent to the second ground terminal 22d in order to improve the quality of signal transmission.

The first conductor 4 includes a first mounting rib 42 located on one side of the first conductor 4 and a second mounting rib 43 located on another side of the first conductor 4. The first mounting rib 42 is received in the first recess 216. The second mounting rib 43 is received in the second recess 217.

In at least two adjacent first conductive pads 41, one of the first conductive pads 41 defines a first notch 413, and a remaining one of the first conductive pads 41 defines a second notch 414. The first notch 413 and the second notch 414 form a first slot 415. The second locking protrusion 2151 extends through the slot 415 and protrudes upwardly beyond the first conductor 4.

The second conductor 5 is mounted to the second insulating block 31. The second conductor 5 is at least partially installed in the mounting groove 120. In the illustrated embodiment of the present disclosure, the second conductor 5 is conductive plastic. The second conductor 5 includes a plurality of second conductive pads 51 arranged at intervals. A second gap 50 is provided between any adjacent two second conductive pads 51. The second gap 50 is located on one side (for example, a lower side) of the third signal terminal 32a and the fourth signal terminal 32b in the second direction A2-A2. The second gap 50 is located between the third signal terminal 32a and the fourth signal terminal 32b in the third direction A3-A3. The second gap 50 is able to prevent signals on the conductive plastic from affecting each other, thereby avoiding signal crosstalk. Referring to FIG. 20, in one embodiment of the present disclosure, a dimension of the second gap 50 along the third direction A3-A3 is D3, and a spacing between the third signal terminal 32a and the fourth signal terminal 32b along the third direction A3-A3 is D4, wherein (1/2)*D4≤D3≤(4/5)*D4.

The second insulating block 31 a plurality of a third retaining grooves 3101 which correspond to the third ground terminals 32c in the second direction A2-A2, and are spaced from the third ground terminals 32c in the second direction A2-A2, and a plurality of fourth retaining grooves 3102 which correspond to the fourth ground terminals 32d in the second direction A2-A2 and are spaced from the fourth ground terminals 32d in the second direction A2-A2. The second insulating block 31 is provided with third inner wall surfaces 3103 located on two sides of the third retaining groove 3101, and fourth inner wall surfaces 3104 located on two sides of the fourth retaining groove 3102.

In two adjacent second conductive pads 51, one of the second conductive pads 51 is provided with a third retaining protrusion 511 fixed in the third retaining groove 3101, and a remaining one of the second conductive pads 51 is provided with a fourth retaining protrusion 512 fixed in the fourth retaining groove 3102. The third retaining protrusion 511 is provided with third ribs 5111 located on two sides thereof. The third ribs 5111 abut against the third inner wall surface 3103. The third ribs 5111 are disposed adjacent to the third ground terminal 32c to improve the quality of signal transmission. The fourth retaining protrusion 512 is provided with fourth ribs 5121 located on two sides thereof. The fourth ribs 5121 abut against the fourth inner wall surface 3104. The fourth ribs 5121 are disposed adjacent to the fourth ground terminal 32d to improve the quality of signal transmission.

The second conductor 5 includes a third mounting rib 52 located on one side of the second conductor 5, and a fourth mounting rib 53 located on another side of the second conductor 5. The third mounting rib 52 is received in the third recess 316. The fourth mounting rib 53 is received in the fourth recess 317.

In at least two adjacent second conductive pads 51, one of the second conductive pads 51 defines a third notch 513, and a remaining one of the second conductive pads 51 defines a fourth notch 514. The third notch 513 and the fourth notch 514 form a second slot 515. The second locking protrusion 2151 extends through the second slot 515 and protrudes downwardly beyond the second conductor 5.

The first mounting block 6 is located on one side (for example, a rear side) of the first terminal module 2, and cooperates with the first terminal module 2. The first insulating block 21 and the first mounting block 6 are both installed at least partially in the mounting groove 120. The first mounting block 6 is provided with a first positioning rib 61 engaged in the first positioning slot 121, and a first locking protrusion 62 locked in the first locking hole 123. In the illustrated embodiment of the present disclosure, two first positioning ribs 61 are provided, and engaged in the corresponding first positioning slots 121. The first mounting block 6 is integrally formed with the first insulating block 21; or the first mounting block 6 and the first insulating block 21 are two parts, and the first mounting block 6 abuts against the first insulating block 21. The first mounting block 6 is provided with a plurality of first positioning protrusions 63 located on an inner side thereof, and a plurality of first positioning grooves 64 of which each is located between any adjacent two first positioning protrusions 63. The first mounting elastic arm 223 is located in a corresponding first positioning groove 64 in order to space adjacent first mounting elastic arms 223.

The second mounting block 7 is located on one side (for example, a rear side) of the second terminal module 3, and cooperates with the second terminal module 3. The second insulating block 31 and the second mounting block 7 are both installed at least partially in the mounting groove 120. The second mounting block 7 is provided with a second positioning rib 71 engaged in the second positioning slot 122, and a third locking protrusion 72 locked in the third locking hole 125. In the illustrated embodiment of the present disclosure, two second positioning ribs 71 are provided, and engaged in corresponding second positioning slots 122. The second mounting block 7 is integrally formed with the second insulating block 31; or the second mounting block 7 and the second insulating block 31 are two parts, and the second mounting block 7 abuts against the second insulating block 31. The second mounting block 7 is provided with a plurality of second positioning protrusions 73 located on an inner side thereof, and a plurality of second positioning grooves 74 of which each is located between any adjacent two second positioning protrusions 73. The second mounting elastic arm 323 is located in a corresponding second positioning groove 74 in order to space adjacent second mounting elastic arms 323.

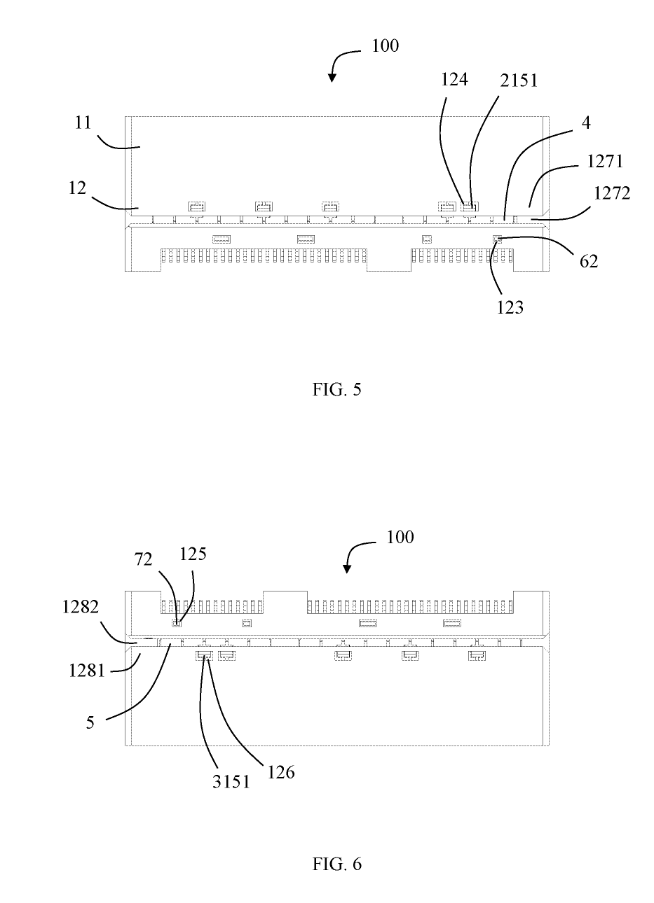

Referring to FIGS. 5 and 6, when the electrical connector 100 is assembled, the first conductor 4 is exposed in the first slit 1272, and the second conductor 5 is exposed in the second slit 1282. When the electrical connector 100 mates with the mating module, metal structures of the mating module are inserted into the first slit 1272 and the second slit 1282 to contact the first conductor 4 and the second conductor 5, thereby facilitating the shielding effect and improving the quality of signal transmission.

Compared with the prior art, the electrical connector 100 of the present disclosure includes the first mounting block 6. The first mounting block 6 is located on one side of the first terminal module 2 and cooperates with the first terminal module 2. The first insulating block 21 and the first mounting block 6 are both installed at least partially in the mounting groove 120. The first mounting block 6 is provided with the first positioning rib 61 engaged in the first positioning slot 121, and the first locking protrusion 62 locked in the first locking hole 123. As a result, the first terminal module 2 can be reliably secured in the insulating body 1.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body comprising a mating portion and a mounting portion; the mating portion comprising a mating face and a mating slot extending through the mating face; the mounting portion defining a mounting groove communicating with the mating slot, a first positioning slot extending through the mounting portion along a first direction, and a first locking hole extending along a second direction; both the first positioning slot and the first locking hole communicating with the mounting groove;
a first terminal module, the first terminal module being at least partially disposed in the insulating body, the first terminal module comprising a first insulating block and a plurality of first conductive terminals coupled to the first insulating block; and
a first mounting block, the first mounting block being located on one side of the first terminal module and cooperating with the first terminal module;
wherein both the first insulating block and the first mounting block are at least partially installed in the mounting groove; and the first mounting block is provided with a first positioning rib engaged in the first positioning slot, and a first locking protrusion locked in the first locking hole.

2. The electrical connector according to claim 1, wherein the first direction is perpendicular to the second direction.

3. The electrical connector according to claim 1, wherein the first mounting block and the first insulating block are integrally formed; or
the first mounting block and the first insulating block are separate components, and the first mounting block abuts against the first insulating block.

4. The electrical connector according to claim 1, wherein two first positioning slots are provided, and the two first positioning slots are located on two sides of the mounting groove, respectively;
two first positioning ribs are provided, and the two first positioning ribs are engaged in corresponding first positioning slots.

5. The electrical connector according to claim 1, further comprising a first conductor mounted to the first insulating block; wherein the first conductor is at least partially mounted in the mounting groove.

6. The electrical connector according to claim 5, wherein the mounting portion defines a second locking hole extending along the second direction;
the first insulating block is provided with a second locking protrusion, and the second locking protrusion passes through the first conductor so as to be locked in the second locking hole.

7. The electrical connector according to claim 6, wherein the first conductor comprises a plurality of first conductive pads;
among at least two adjacent first conductive pads, one first conductive pad defines a first notch, and another first conductive pad defines a second notch; the first notch and the second notch jointly form a first slot; and the second locking protrusion extends through the first slot so as to extending beyond the first conductor.

8. The electrical connector according to claim 5, wherein the first conductor comprises a plurality of first conductive pads which are disposed at intervals, and a first gap is formed between every two adjacent first conductive pads;
the plurality of first conductive terminals comprise a first signal terminal and a second signal terminal; the first signal terminal and the second signal terminal form a first differential pair; the first gap is located on one side of the first signal terminal and the second signal terminal along the second direction; the first gap is located between the first signal terminal and the second signal terminal along a third direction; and the third direction is perpendicular to the first direction and the second direction.

9. The electrical connector according to claim 8, wherein a dimension of the first gap along the third direction is D1; and a spacing between the first signal terminal and the second signal terminal along the third direction is D2, wherein (1/2)*D2≤D1≤(4/5)*D2.

10. The electrical connector according to claim 5, wherein the first conductor is made of conductive plastic; the plurality of first conductive terminals comprise a first ground terminal; the first insulating block defines a first retaining groove; the first retaining groove corresponds to the first ground terminal along the second direction, and is spaced from the first ground terminal along the second direction; and the first conductor is provided with a first retaining protrusion secured in the first retaining groove.

11. The electrical connector according to claim 10, wherein the first insulating block is provided with first inner wall surfaces located on two sides of the first retaining groove, respectively;
the first retaining protrusion is provided with first ribs located on two sides thereof; and the first ribs abut against the first inner wall surfaces.

12. The electrical connector according to claim 5, wherein the first insulating block comprises a first protruding portion, a first recess located on one side of the first protruding portion, and a second recess located on another side of the first protruding portion; and
wherein the first conductor comprises a first mounting rib located on one side thereof and a second mounting rib located on another side thereof; the first mounting rib is received in the first recess, and the second mounting rib is received in the second recess.

13. The electrical connector according to claim 1, wherein each first conductive terminal comprises a first fixing portion secured to the first insulating block, a first mating elastic arm extending from one end of the first fixing portion, and a first mounting elastic arm extending from another end of the first fixing portion; the first mating elastic arm is provided with a first contact portion protruding into the mating slot; and the first mounting elastic arm is provided with a first abutting portion protruding into the mounting groove.

14. The electrical connector according to claim 13, wherein the first mounting block is provided with a plurality of first positioning protrusions and a plurality of first positioning grooves; each first positioning slot is located between every two adjacent first positioning protrusions; and the first mounting elastic arm is positioned in a corresponding first positioning groove.

15. The electrical connector according to claim 1, wherein the mounting portion defines a second positioning slot extending through the mounting portion along the first direction, and a second locking hole extending along the second direction; both the second positioning slot and the second locking hole communicating with the mounting groove;
wherein the electrical connector further comprises a second terminal module and a second mounting block; the second terminal module is at least partially disposed in the insulating body, and comprises a second insulating block and a plurality of second conductive terminals coupled to the second insulating block; each second conductive terminal comprises a second fixing portion secured to the second insulating block, a second mating elastic arm extending from one end of the second fixing portion, and a second mounting elastic arm extending from another end of the second fixing portion; the second mating elastic arm is provided with a second contact portion protruding into the mating slot; and the second mounting elastic arm is provided with a second abutting portion protruding into the mounting groove; and
wherein the second mounting block is located on one side of the second terminal module and cooperates with the second terminal module; both the second insulating block and the second mounting block are at least partially installed in the mounting groove; and the second mounting block is provided with a second positioning rib engaged in the second positioning slot, and a second locking protrusion locked in the second locking hole.

16. The electrical connector according to claim 15, wherein the first insulating block and the second insulating block are provided with a positioning post and a positioning hole; and the positioning post is received in the positioning hole.

17. The electrical connector according to claim 15, wherein the first insulating block and the second insulating block are provided with a locking elastic arm and a locking boss; and the locking elastic arm mates with the locking boss.

18. The electrical connector according to claim 17, wherein the first insulating block comprises a first notch located on one side thereof and a first engaging elastic arm located on another side thereof; the first insulating block comprises a first boss located in the first notch; and the first engaging elastic arm is provided with a first locking hook;
wherein the second insulating block comprises a second notch located on one side thereof and a second engaging elastic arm located on another side thereof; the second insulating block comprises a second boss located in the second notch; and the second engaging elastic arm is provided with a second locking hook;
wherein the first engaging elastic arm is received in the second notch; the first locking hook is locked with the second boss; the second engaging elastic arm is received in the first notch; and the second locking hook is locked with the first boss; and
wherein the locking elastic arm comprises the first engaging elastic arm and the second engaging elastic arm, and the locking boss comprises the first boss and the second boss.

19. The electrical connector according to claim 1, wherein the first insulating block defines a first impedance adjustment hole extending along the second direction; and the first impedance adjustment hole is located between two adjacent first conductive terminals; and
wherein the first insulating block comprises a first surface and a second surface disposed opposite to the first surface; and the first impedance adjustment hole extends through at least one of the first surface and the second surface.

20. The electrical connector according to claim 1, wherein the mounting portion comprises a first wall portion; and the first wall portion comprises a first outer surface and a first slit extending through the first outer surface along the second direction; and
wherein the electrical connector further comprises a first conductor mounted to the first insulating block; and the first conductor is exposed in the first slit.
